(19) United States
(12) Patent Application Publication
(10) Pub. No.: US 2022/0386572 A1
(43) Pub. Date: Dec. 8, 2022

(54) Outdoor Feature

(71) Applicant: BIOSCAPE LIMITED, London (GB)

(72) Inventor: Paul Andrew DAWSON, York (GB)

(21) Appl. No.: 17/773,615

(22) PCT Filed: Apr. 7, 2020
(86) PCT No.: PCT/GB2020/050911

§ 371 Date: May 1, 2022

(30) Foreign Application Priority Data
Nov. 7, 2019 (GB) 1916191.8

(51) Int. Cl. A01K 63/00; A01G 9/02

(52) U.S. Cl. CPC A01K 63/003; A01G 9/023; A01G 9/028

(57) ABSTRACT

The invention concerns an outdoor bio-tower (10) for placing in a garden or on a patio, wherein the bio-tower (10) promotes biodiversity in outdoor environments. The bio-tower (10) comprises a framework defining a plurality of compartments each providing separate habitats suited to different species of flora, fauna, micro-organisms and/or fungi. The compartments include at least a first internal dry compartment with an access for creatures requiring a dry habitat, and at least one separate second internal wet compartment containing a tray (27) which may retain water and access for creatures requiring a wet habitat. The two internal compartments are surrounded at least in part by external compartments filled with a growing medium, such as soil, that serve for growing plants and that offer insulation to the internal compartments.

### FIELD OF THE INVENTION

The present invention relates to an outdoor feature for placing in a garden or on a patio, both in private homes and public spaces such as golf courses, schools and hospitals as well commercial developments, roof gardens or urban environments.

### OBJECT OF THE INVENTION

The aim of the invention is to provide a decorative feature that promotes and enhances biodiversity.

### SUMMARY OF THE INVENTION

According to the present invention, there is provided an outdoor feature comprising a framework defining a plurality of compartments each providing separate habitats suited to different species of flora, fauna, micro-organisms and/or fungi, the compartments including at least a dry first internal compartment with an access for creatures requiring a dry habitat, and at least one separate second internal compartment containing a tray which can retain water and provides access for creatures requiring a wet habitat, the two compartments being surrounded at least in part by further compartments filled with a growing medium, such as soil, that serve for growing plants and that offer insulation to the internal compartments.

The feature of the invention is a product that contains different habitats to promote flora, fauna, wildlife, biodiversity etc, wherever the product is placed. The feature may be in the form of a cube with sides of approximately 1 to 1.5 meters. The feature has internal compartments with openings to the exterior, designed to provide habitats for different species. Thus, a first compartment comprises a tray which can retain water, covered with stones etc, creating spaces for creatures such as newts, frogs, toads and micro-organisms. A separate compartment is also provided for creatures such as hedgehogs, which need to be dry.

The framework of the outdoor feature should preferably have sufficient structural rigidity to permit the feature, when fully assembled and filled, to be raised off the ground and transported to a different location while retaining its structural integrity.

With a view to simplifying transportation, construction and storage, in preferred embodiment, the framework of the outdoor feature comprises a housing that is sub-divided into wet and dry compartments, wherein at least two of the compartments are vertically spaced from one another within the housing, and wherein the housing is of modular construction, being formed of a plurality of sections stacked one above the other.

In some embodiments, the sections are shaped for form-locking engagement with one another to prevent relative horizontal movement between the sections and to transmit the load of each upper section to the next lower section.

Each section may be formed of an open frame having straight or curved sides connected to one another at each corner by a respective structural element through which the load of each upper section is transmitted to the next lower section.

Tongues and grooves may be provided on the longer edges of the sides of the sections to ensure that corresponding sides of vertically adjacent sections mate with one another, thereby maintaining the sides in the same plane as each other and preventing sections from sliding relative to one another.

An internal floor member may be provided between two sections of the stack, the floor member being supported by the structural corner elements of the lower of the two sections.

The floor member may serve to support a water-retaining tray, made for example of a plastic material. The tray may itself be filled with loose stones to provide a habitat for animal species requiring a wet environment and the floor member may include an opening for permitting access to this habitat.

The tray may further serve to support a soil-filled container, which may suitably be a wire basket lined with a plastics or woven bag filled, preferably to the top, with soil.

In some embodiments, the soil cage may be more robust being possibly of folded steel plate construction with laser cut holes. If the soil cage is manufactured from folded steel and is made more robust, it may be integrated with the water retaining tray, the latter being made of metal rather than a plastics material. In this case, the tray may be fabricated from steel, hot-dip galvanised, and powder coated so that it does not corrode and retains water. In such an embodiment, it would be possible to lift out the water retaining tray along with the ‘soil cage’ as one piece by lifting the soil cage from above.

Such an operation would require a forklift or crane or similar lifting device but it would allow topping up the wood material in the base of the unit without having to try to get top-up wood material through the side doors. In such a construction, the steel retaining plate located beneath the plastic tray may no longer be required, it being sufficient to support the metal tray at each corner.

The water retaining tray and soil cage may also be secured to a metal base unit, to allow the whole unit to be lifted from above by a forklift or crane and hook mechanism making it easier to move and relocate the unit (this is in addition to being able to lift out just the tray and soil cage as described above).

The term “soil” is used herein to include any medium capable of supporting plant growth, for example compost. The tray may serve to water the plants in the soil-filled container and may provide a space into the which the roots of plants in the container may spread.

If the soil-filled container occupies an area smaller than that of each frame, the space between the container and the surrounding frame may serve as a separate habitat.

The soil-filled container may project beyond the uppermost section, and an insect or bug hotel, or a hive for bees, may be supported on a protruding region of the container.

It is possible for the sides not to be vertical and for the structure to be slightly pyramidal, tapering upwards or downwards. However, it is preferred for the sides of the sections to be vertical, so that all the sections may be made of a uniform size.

If desired, the sides of only the uppermost section may be inclined outwardly, to enlarge the volume of the habitat surrounding the soil-filled container.

The space beneath the internal floor may serve as a separate habitat and may be filled with a material such as matting, straw, bark, wood shavings and some stones. A wood material would not only provide a habitat but also serve as a food source for some species and fungi.

In one embodiment, the feature is designed for ease of transportation after it has been erected. For this purpose, openings may be formed in at least two sides of the lowermost of the frames, sized and positioned to receive lifting tines of a fork-lift truck or lifting device. The same openings can serve as access holes to the compartment defined within the lowermost section.

In order that the entire weight should not be supported solely by two sides of the lowermost section, the frames lower than the floor member may be fitted with at least one internal vertical partition, and the partition(s) of the lowermost section formed with openings aligned with the openings in the sides of the frame. As an alternative, the base may be made from steel, and may incorporate a mechanism to allow it to be connected to the soil cage and tray to allow it to be lifted as one unit.

At least one opening may be provided in a frame of the housing and a drawer or box enclosing a separate habitat may be slidably received in the opening.

Embodiments of the invention provide both wet and dry habitats suited to different species of flora and fauna. Upper open compartments of the feature are intended for plants, which will be watered naturally or topped up by means of a hose. A water retaining tray beneath the upper compartments serves to collect rainwater so as to provide a wet habitat, for example for amphibians. The water retaining tray and the floor member on which it rests provide beneath them a dry habitat for still other species.

If desired, drain holes may be drilled in the top of the sides of the tray so when over filled either by rainwater or hose the overflow water drops down onto the wet habitat (tray) located below the drain holes.

In some embodiments, access to a dry compartment may be via a third compartment, designed to prevent predators such as dogs and badgers, from entering the dry compartment. All the internal compartments may preferably be ventilated.

The wet compartments may be contained within the centre of the feature and surrounded by areas to be filled with bark and/or wood material or with low fertility soil containing mixes of various wildflower species, grasses and buddleia. The soil filled compartments also help to protect and insulate/moderate the temperature and noise in the central compartments.

The aim of the mixes is to promote birds, bees, bugs, caterpillars etc once the seed germinates, and to provide an attractive finish to the feature.

In some embodiments, compartments at the top of the feature may be filled with soil within which more drought tolerant plants are planted.

In practice, it is expected in some cases that the feature would be purchased prefilled with stones, twigs, bark, soil, wildflower seed etc. In such a case, the feature is likely to weigh approximately a tonne and therefore needs to be structurally sound to allow it to be lifted. Alternatively, the framework may be supplied as a flat pack, for assembly by the end user, in which case the other components, such as soil mixes, stones, timber, pipes etc could be purchased and supplied separately.

It is envisaged that the feature could be set into the ground, within a hole dug to a depth of 15 cm to 30 cm. Setting the feature into the ground provides additional protection and temperature moderation to the lower compartments.

To further encourage biodiversity, the feature may further include a birdbath.

To top up the water in the water retaining tray, a rain collecting tray may further be provided at the top of the feature and it may be connected by a pipe to the water retaining tray. As an alternative, the water may be topped up by means of a hose or watering can.

In some embodiments, a drainage pipe may be provided to prevent excess water from accumulating in the water retaining tray and to supply water to wet habitat located below.

The feature may be designed to be connected to other similar features to allow larger features to be constructed in a modular fashion, with possible passages interconnecting the compartments of adjacent features.

In an embodiment of the invention, the framework of the feature is constructed from a biodegrading material, such as a soft wood. In this case, the framework of the feature could deteriorate over time, leaving a natural mound of timber, stone, soil, still providing various habitats, in a more natural way.

In an alternative embodiment, the framework may be constructed of more durable materials, in order to retain its integrity for many years.

Planners and local authorities have a responsibility to promote biodiversity and enhance wildlife and the present invention provides them with the opportunity to meet this demand in one convenient product. The types of fauna that the feature can be used to attract include various micro-organisms, toads, frogs, newts, solitary bees, birds, butterflies, moths, hedgehogs, ladybirds, woodlice, beetles, centipedes, spiders, lacewings and bugs generally.

The feature of the invention may be provided with accessories that are initially secured to the framework but intended to be separated and mounted at a different location. For example, a readymade bat box or birdbox may be attached to the feature which could then be removed and installed on a tree/house adjacent to the feature.

Various modifications and additions may be made to the feature as described above. As an example, part of the framework may be formed with holes to be inhabited by bees and bugs. Parts of the exterior may be formed of natural tubing, such as bamboo canes, to provide further habitats for some of the species mentioned.

### BRIEF DESCRIPTION OF THE DRAWINGS

The invention will now be described further, by way of example, with reference to the accompanying drawings, in which:

FIG. 1 is a perspective view from above of an assembled outdoor feature of an embodiment of the invention,

FIG. 2 is a perspective view from below of the outdoor feature of FIG. 1,

FIG. 3 is a detail of FIG. 2 drawn to an enlarged scale, showing how the sides of each section are secured to one another,

FIG. 3a show a section of an alternative construction for securing the sides of each section to one another at each corner,

FIG. 4 is a perspective view of one of the components shown in FIG. 3,

FIG. 5 is a perspective view of a separate box that may be inserted into the outdoor feature of FIGS. 1 and 2 to provide a further separate habitat,

FIG. 6 is a closure panel than can be used in conjunction with the box shown in FIG. 5,

FIG. 7 shows a perspective view of one of the sides of the uppermost section of the outdoor feature of FIGS. 1 and 2, and

FIG. 8 is a computer-generated exploded view of an embodiment of the invention.

### DETAILED DESCRIPTION OF THE DRAWINGS

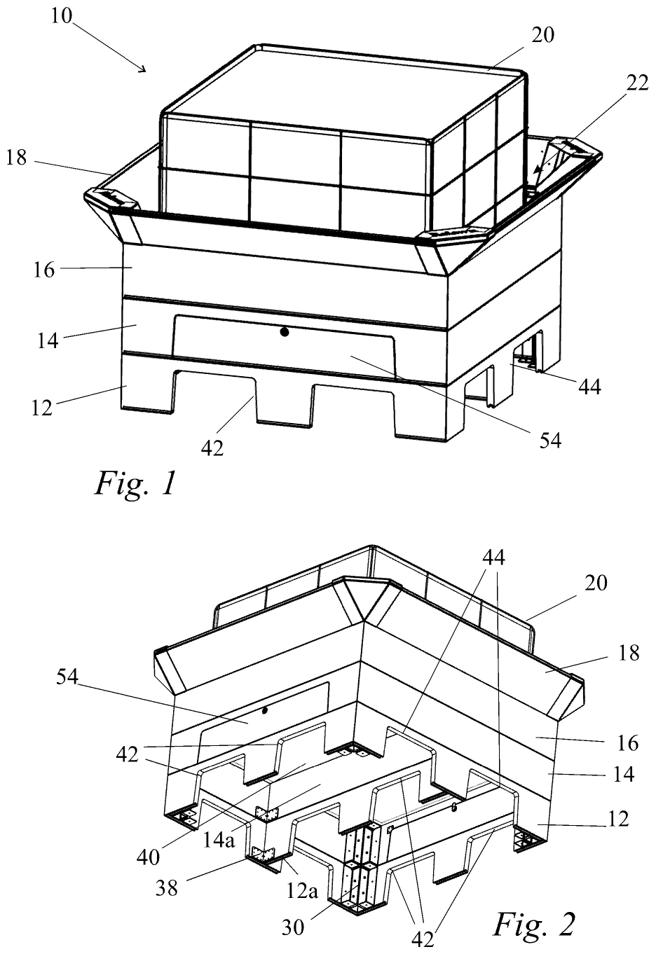

The outdoor feature 10 shown in FIGS. 1 and 2 is generally cube-like and would typically have sides with a length in the region of 1 m to 1.5 m. For convenience, it is referred to herein as a bio-tower. As can be seen from the drawings, the bio-tower 10 is of modular construction, being formed, in the case of the illustrated embodiment, of four sections 12, 14, 16 and 18 stacked vertically one above the other.

The bio-tower 10 in FIG. 1 is shown as a stand-alone feature but this need not be the case. Several bio-towers can be positioned next to one another and they need not all have the same number of stacked sections. The bio-towers may be locked or connected together, with access from one habitat in one bio-tower directly connected to a similar habitat in the next bio-tower. Being modular, the height of each bio-tower may be increased or decreased by adding or removing sections.

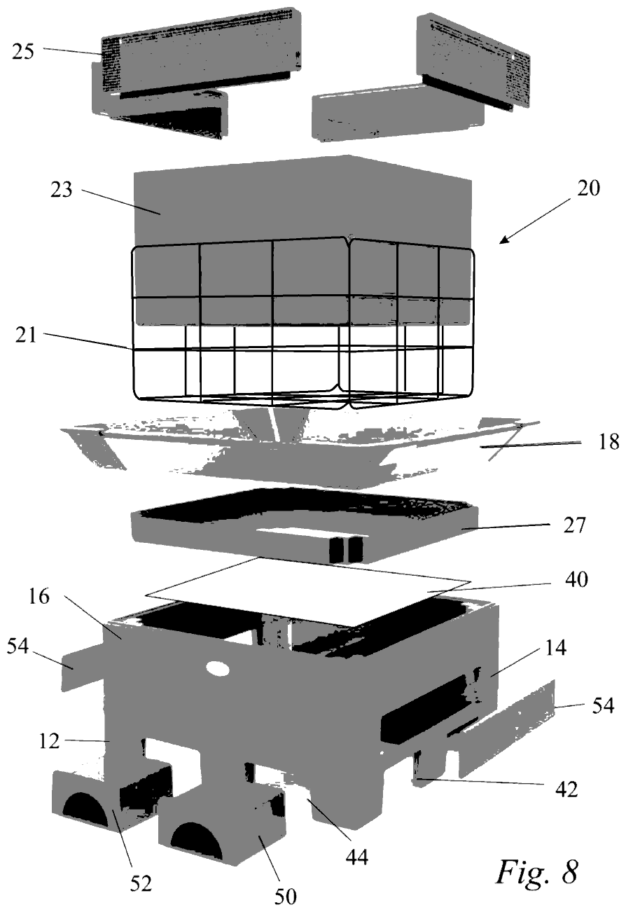

The aim of the invention is to provide a decorative feature that is also designed to increase biodiversity. The top of each bio-tower forms an area in which plants can grow. In the illustrated embodiment, a soil-filled container 20 is located at the top of the bio-tower 10 and is surrounded by a drained trough 22 defined between it and the surrounding uppermost section(s) 16 and 18 of the bio-tower 10. In the illustrated embodiment, the soil-filled container rests on a plastic tray 27 (see FIG. 8) that may be filled with loose stone, and it in turn is supported by a floor member 40, which may be a metal plate. As earlier mentioned, it would be alternatively possible to form a tray of metal rather than a plastics material and it would be connected to the soil filled container 20. The dry volume disposed beneath the growing plants and the wet habitat defined by the tray 27, are separated into different compartments that are sheltered from the elements and designed to provide habitats suited to different animal species.

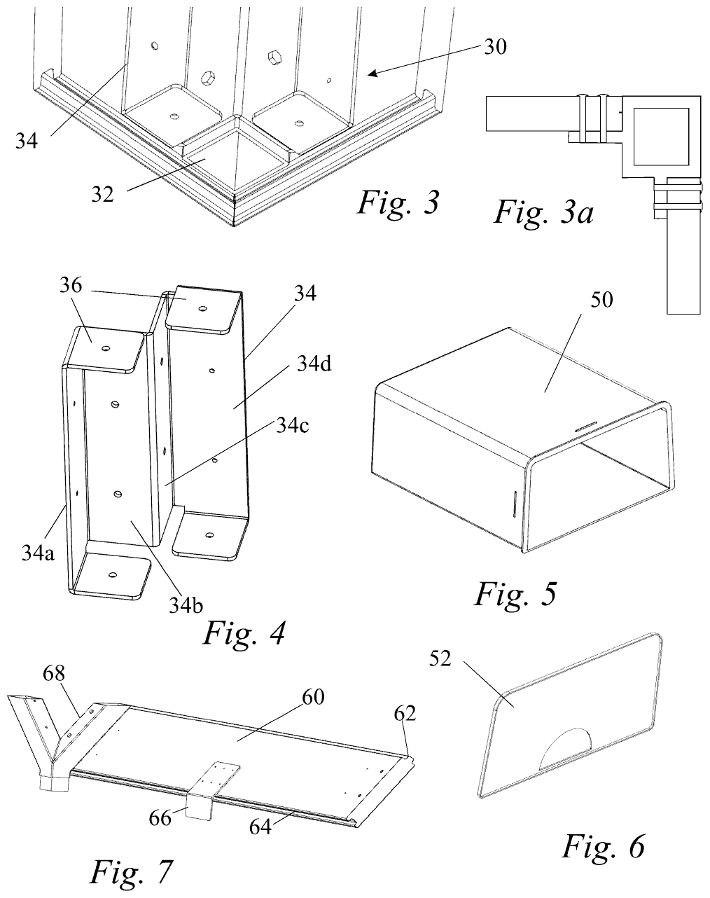

Each of the sections 12, 14 and 16 comprises a frame having four vertical sides that are connected to one another at the corners by means of load-bearing structures 30, which are described in greater detail below by reference to FIGS. 3 and 4. The sides are made up of tongue and groove boards which mate with one another when the sections are stacked one above the other as shown in FIGS. 1 and 2. This establishes a form-locking engagement between the sections, preventing them from sliding relative to one another. The tongue and groove boards can be made of wood, or any composite material capable of withstanding the weather conditions. In the illustrated embodiment, the sides of the individual sections are not called up to support all the weight of the soil and plants in the growing area, as much, if not all, of the load is supported by the corner structures 30. It would however be alternatively possible for the lower section to be made of metal and to have sufficient strength and rigidity to support the weight of the entire bio-tower

As illustrated by way of example, each of the load-bearing corner structures 30 is made up of two components of which the first is a tube 32 of square cross section of which only the projecting lower end is seen in FIG. 3. The sides of each section are directly secured to this tube 32.

In the alternative construction shown in FIG. 3a, each corner comprises a square section tube with two projecting flanges to which the sides are screwed. In this embodiment, a pole may be inserted into the central holes of the square section tubes of the different overlying sections one they have been aligned with one another.

The second component is a bracket 34, shown separately in FIG. 4 that has four vertical plates 34a, 34b, 34c and 34d that are at rights angles to one another. The two central plates 34b and 34c are secured to the tube 32. The two end plates 34a and 34d are secured to sides of the section and additional have bent end flanges 36 at their upper and lower ends. These flanges 36 serve to transmit load between the sections and may also, if desired, enable adjacent sections to be bolted to another. As can be seen from FIGS. 3 and 4, the tubes 32 and the brackets 34 have holes for receiving fixings to secure them to one another and to the sides of each section.

In an alternative embodiment, not shown in the drawings, the plates 34b and 34c are extended upward further than the flanges 36 and bent to form a spigot of square section that can be received in the lower end of the next higher tube 32 in order to ensure vertical alignment of the tubes 32.

The weight of the soil-filled container 20 rests on a plastics tray 27 that is filled with loose stones and it is itself supported by a floor member 40 that is sandwiched between the sections 14 and 16 and that rests on the flanges 36 at the four corners of the section 14. To support the floor member 40 further, the two sections 12 and 14 beneath it are formed with central partitions 12a and 14a. These partitions may be made from the same material as the sides of the sections and are secured to them by means of angle brackets 38.

Two of the sides of the lowermost section 12 and its central partition 12a are each formed with two cut-outs 42 to receive the tines of a forklift truck or lifting straps connected to a crane. These allow the bio-tower 10 to be moved without the need for it to be dismantled.

Additionally, the other two sides of the lowermost section 12 are formed with cut-outs 44 that can be used to receive boxes 50, as shown in FIG. 5. Depending of the type of fauna to be provided with a habitat in these boxes 50, they may either be left wide open or their entrances may be restricted by means of a closure panel 52, as shown in FIG. 6. Such habitats can be individually designed by their shape, positioning and contents to attract different animal species. For example, boxes with a small entrance at a high level would be suited to birds, while boxes at ground level and with larger entrances are better suited to hedgehogs. Furthermore, the different habitats may have different humidity, with some being wet and others dry. If a compartment is required to have water, an internal drainage tube may connect it to the tray 27 that can collect rainwater or be filled by a hose through a pipe.

The volume beneath floor member 40 is designed to be filled with a material, such as bark or stones, that can serve as bedding and possibly as food for some animals that can access this space through the openings 42. Removable inspection/access panels 54 are provided in the section 14 for maintenance, for example to allow replacement of the bark or wood material. As an alternative to the panels 54, it may be possible in an alternative embodiment to raise the solid cage and tray as described above.

In this way, the volume of the bio-tower beneath internal floor member can be designed to provide multiple habitats suited to different flora, fauna and fungi.

The part of the bio-tower above the floor member is not sheltered from the elements and can receive rainwater. In the illustrated embodiment, it is separated into two different regions by the provision of the soil-filled container 20. This need not, however, always be the case because the entire top section could be a tray filled with soil. The advantage of using a soil-filled container is that it can provide vertical separation between plants and also that it allows the soil conditions within the container 20 to differ from the those in the surrounding trough 22. Its advantages are therefore both aesthetic and functional.

To reduce the weight of the soil-filled container 20, it may be formed of a wire basket 21 lined with a plastics membrane 23 that preferably extends to the top of the basket 21. The plastics membrane may be woven or, if made of a continuous sheet, holes may be provided or formed in it to allow water to drain. The sides of the wire basket 21 projecting higher than the sides of the top section 18 of the bio-tower 10 can be used for hanging insect hotels 25. It may alternatively be preferred to form the soil-filled container in a more robust manner as described above.

As the tray 27 disposed beneath the trough 22 and the soil-filled container contains loose stones or crushed rocks, it can collect rainwater and serve for irrigation. The roots of plants in both the trough 22 and the container 20 may spread into the tray 27. The tray itself forms a suitable habitat for species that require a wet environment and it is possible to provide openings in the supporting metal floor 40 to provide access to this habitat from the underside of the bio-tower 10.

It is desirable to enlarge the trough 22 by inclining the sides of the uppermost section 18 of the bio-tower 10 in the manner shown n FIGS. 1 and 2. One of the sides 60 of such an uppermost section 18 is shown in FIG. 7. The side 60 is formed of the same boards as the sides of the remaining sections and thus has a tongue 62 and a groove 64. However, in this case, the corners of the section are constructed differently and include a Y-shaped bracket 68 designed to receive a small triangular insert as shown in FIGS. 1 and 2.

Because of the inclination of the sides 60 of the uppermost section, their groove cannot fully receive the tongue projection from the next lower section. For this reason, it is desirable to fit the sides with brackets 66 to locate the uppermost section on the section beneath it.

The bio-tower 10 of the preferred embodiment of the invention are designed for ease of storage, transportation and assembly. It is possible for the entire bio-tower 10 to be flat packed or the individual sections may be pre-assembled. Each section or module is of a size permitting it to be moved without the need for heavy lifting equipment and assembly requires no more than stacking of the modules above one another and locating the internal floor member 40 and the tray 27 at the designed height. Should it be necessary to move the bio-tower after a length of time, it is capable of being lifted without the need for it to be dismantled.

It should be clear to the person skilled in the art that various modifications may be made to the embodiments of the invention described above without departing from the scope of the present invention as set forth in the appended claims. In particular, the shape, size and number of modules, as may the number of separate habitats defined within the bio-tower, be it by sub-division using partitions or by additional of removable boxes or drawers. Furthermore, while it is desirable, from the point of view of ease of assembly, for the modules merely to need to be stacked one above the other, it would alternatively be possible to provide fixings to secure adjacent modules to one another.

1. An outdoor feature comprising:
a framework having:
at least one internal dry compartment with an access for creatures requiring a dry habitat;
at least one separate second internal wet compartment contiguous to the first compartment, the wet compartment comprising a tray capable of retaining water and access for creatures requiring a wet habitat;
an external compartment or compartments surrounding at least partially the dry and wet compartments filled with a growing medium.

2. An outdoor feature as claimed in claim 1, wherein the framework is constructed with sufficient structural rigidity to permit a fully assembled and filled feature to be raised off the ground and re-laid thereupon while retaining its structural integrity.

3. An outdoor feature as claimed in claim 1, wherein the framework comprises a housing that is sub-divided into compartments, wherein at least two of the compartments are vertically spaced from one another within the housing, and wherein the housing is of modular construction, being formed of a plurality of sections stacked one above the other.

4. An outdoor feature as claimed in claim 3, wherein the sections are shaped for form-locking engagement with one another to prevent relative horizontal movement between the sections and to transmit a load associated with an upper section to a next lower section.

5. An outdoor feature as claimed in claim 4, wherein each section comprises a plurality of frame sides, each two adjacent frame sides being coupled to one another by a respective structural element through which the load of each upper section is transmitted to the next lower section.

6. An outdoor feature as claimed in claim 5, wherein tongues and grooves mating interface is provided between longer edges of respective frame sides of vertically adjacent sections, so as to provide form-locking engagement between the sections, thereby maintaining the respective frame sides in the same plane as each other and preventing sections from sliding relative to one another.

7. An outdoor feature as claimed in claim 4, wherein the sections are of a uniform cross-sectional size.

8. An outdoor feature as claimed in claim 5, wherein at least one section comprises an internal floor member supported by the structural corner elements of the lower section.

9. An outdoor feature as claimed in claim 8, further comprising a water retaining tray is supported by the floor member.

10. An outdoor feature as claimed in claim 9, further comprising a soil-filled container that is connected to, or rests on the tray.

11-12. (canceled)

13. An outdoor feature as claimed in claim 9, wherein the soil-filled container occupies an area smaller than that of each frame, a space between the container and a surrounding frame serving as a separate habitat.

14. An outdoor feature as claimed in claim 13, wherein the frame sides of the uppermost section are outwardly inclined.

15. An outdoor feature as claimed in claim 8, further comprising a spate habitat having bedding material therein, the separate habitat being disposed at a space beneath the internal floor.

16. An outdoor feature as claimed in claim 8, wherein openings are formed in at least two sides of the lowermost of the frames, sized and positioned to receive lifting tines of a fork-lift truck.

17. An outdoor feature as claimed in claim 16, wherein the frames lying below the floor member are each fitted with at least one internal vertical partition, the partition in the lowermost frame being formed with openings aligned with the openings in the sides of the frame.

18. An outdoor feature as claimed in claim 3, wherein at least one opening is provided in a frame of the housing and wherein a drawer enclosing a separate habitat is slidably received in the opening.

19. An outdoor feature as claimed in claim 9, wherein the tray provides a wet habitat accessible through an opening formed in the underlying floor member.
